(19) United States
(12) Patent Application Publication
(10) Pub. No.: US 2018/0107196 A1
(43) Pub. Date: Apr. 19, 2018

(54) Method of Detecting Home Appliance Bus Control System

(71) Applicant: Tyco Electronics (Shanghai) Co. Ltd., Shanghai (CN)

(72) Inventors: Weifeng Bian, Shanghai (CN); Yulin Feng, Shanghai (CN); Yuming Song, Shanghai (CN)

(73) Assignee: Tyco Electronics (Shanghai) Co. Ltd., Shanghai (CN)

(21) Appl. No.: 15/841,840

(22) Filed: Dec. 14, 2017

Related U.S. Application Data
(63) Continuation of application No. PCT/IB2016/053458, filed on Jun. 12, 2016.

(30) Foreign Application Priority Data
Jun. 15, 2015 (CN) 201510329166.2

(51) Int. Cl. G05B 19/418

(52) U.S. Cl. CPC G05B 19/4183; G08B 23/00; G05B 19/4185

(57) ABSTRACT

A method of detecting a status of a home appliance control system comprises collecting communication data transmitted on a communication bus of the home appliance bus control system and judging in real-time and online whether the collected communication data meet a preset alarm condition. The collection of the communication data is terminated if the collected communication data meet the preset alarm condition and the collection of the communication data is continued if the collected communication data do not meet the preset alarm condition. The method further comprises graphically displaying the collected communication data to obtain an actual test diagram of the collected communication data and analyzing the collected communication data based on the actual test diagram of the collected communication data to obtain an analysis result.

### CROSS-REFERENCE TO RELATED APPLICATIONS

This application is a continuation of PCT International Application No. PCT/IB2016/053458, filed on Jun. 12, 2016, which claims priority under 35 U.S.C. § 119 to Chinese Patent Application No. 201510329166.2, filed on Jun. 15, 2015.

### FIELD OF THE INVENTION

The present invention relates to a bus control system and, more particularly, to a method of detecting a status of a bus control system of a home appliance.

### BACKGROUND

A control system for a home appliance, for example a washing machine or a refrigerator, generally is a centralized control system having only a single controller. All execution components and/or sensing components, such as valves, sensors, and motors, of the home appliance are directly connected to the single controller. In such a centralized home appliance control system, it is difficult to collect and detect in real time the control logic of the control software and the states of most of the execution components and/or the sensing components. In the prior art, only part of the data of the execution components and/or the sensing components may be collected for testing of the control system and only by providing some additional sensors, and a running state of the tested home appliance may be obtained based on an analysis result of the collected data.

Detecting a status of a control system in the prior art, consequently, requires costly additional sensors, cannot collect all data of the execution components and/or the sensing components, and cannot detect the control logic of the control software. The testing of the control system cannot detect in real-time the running state of the home appliance and output in real-time a fault alarm and cannot graphically and visually display the running state of the home appliance, increasing the difficulty of detecting the running state of the home appliance.

### SUMMARY

A method of detecting a status of a home appliance control system according to the invention comprises collecting communication data transmitted on a communication bus of the home appliance bus control system and judging in real-time and online whether the collected communication data meet a preset alarm condition. The collection of the communication data is terminated if the collected communication data meet the preset alarm condition and the collection of the communication data is continued if the collected communication data do not meet the preset alarm condition. The method further comprises graphically displaying the collected communication data to obtain an actual test diagram of the collected communication data and analyzing the collected communication data based on the actual test diagram of the collected communication data to obtain an analysis result.

### BRIEF DESCRIPTION OF THE DRAWINGS

The invention will now be described by way of example with reference to the accompanying Figures, of which:

FIG. 1 is a block diagram of a home appliance bus control system according to an embodiment of the invention;

FIG. 2 is a block diagram of a home appliance bus control system according to another embodiment of the invention;

FIG. 3 is a block diagram of a home appliance bus control system according to another embodiment of the invention; and

FIG. 4 is a block diagram of a detection apparatus of the home appliance bus control system.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

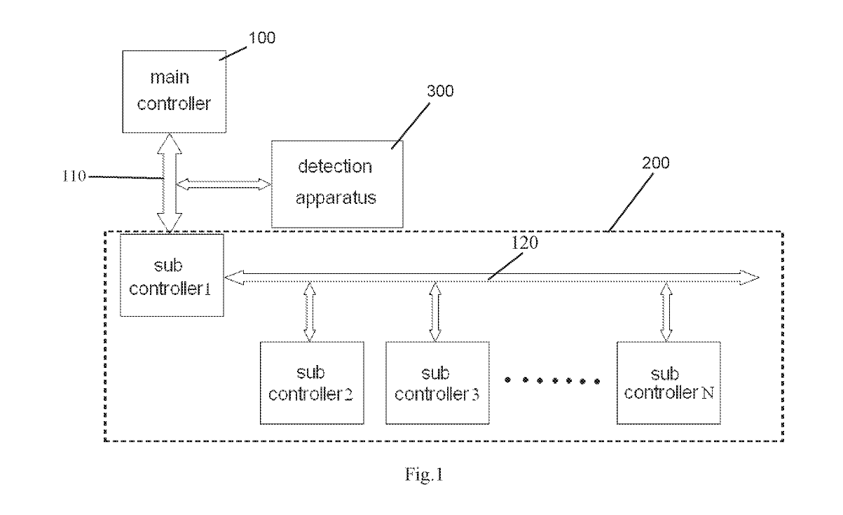

A home appliance bus control system according to an embodiment of the invention is shown in FIG. 1. The home appliance bus control system comprises a main controller 100 and a sub control system 200. As shown in FIG. 1, the sub control system 200 comprises a plurality of sub controllers. The plurality of sub controllers are sequentially numbered as the sub controller 1, the sub controller 2, the sub controller 3, . . . , the sub controller N.

As shown in FIG. 1, the main controller 100 is connected to one (the sub controller 1) of the plurality of sub controllers through a first communication bus 110. The sub controller 1, the sub controller 2, the sub controller 3, . . . , the sub controller N are connected to a second communication bus 120 in parallel. In other embodiments, the main controller 100 may be connected to another (for example, the sub controller 2, the sub controller 3, . . . , or the sub controller N) of the plurality of sub controllers through the first communication bus 110.

The main controller 100 operates a main control logic of the home appliance and sends a control instruction to the sub controller 1 connected to the main controller through the first communication bus 110. The sub controller 1 is configured to receive the control instruction and transfer the control instruction to each of the other sub controllers 2-N. Also, the sub controller 1 is configured to receive data from the other sub controllers 2-N and send the data of the other sub controllers 2-N and the data of itself back to the main controller 100. The sub controllers 1-N each directly control an execution component and/or a sensing component, for example, valves, motors, sensors, based on the received control instruction.

As shown in FIG. 1, a detection apparatus 300 is connected to the first communication bus 110 between the main controller 100 and the sub controller 1. The detection apparatus 300 comprises a data collection device configured to collect the communication data transmitted on the first communication bus 110. In an embodiment, the detection apparatus 300 is a computer having a processor and a memory, the memory being a non-transitory computer readable medium. Computer software used to detect and analyze the collected communication data is stored on the memory and run in the processor of the detection apparatus 300.

The detection apparatus 300 further comprises a prejudge device configured to judge in real time and online whether the collected communication data meet a preset alarm condition. If the judgment result is yes, then it may determine that the collected communication data is abnormal. In this case, the detection apparatus 300 outputs an alarm and terminates the collection of the communication data, saving the test time and the test cost and avoiding collecting a large amount of abnormal data.

The detection apparatus 300 further comprises a graphic device configured to generate and display an actual test diagram of the communication data based on the collected communication data. The detection apparatus 300 further comprises an analysis device configured to analyze the collected communication data based on the actual test diagram of the communication data and obtain an analysis result.

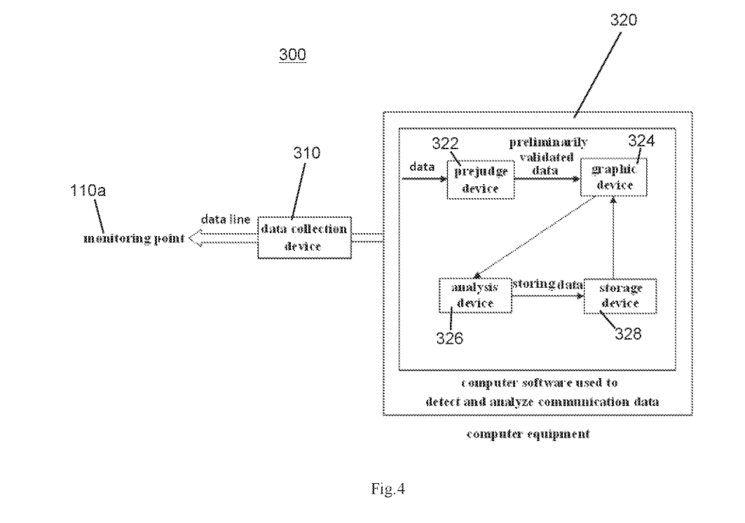

A functional block diagram of the detection apparatus 300 is shown in FIG. 4.

As shown in FIG. 4, the data collection device 310 is connected to a monitoring point 110a of the communication bus 110 through a data line. The data collection device 310 is configured to collect the communication data transmitted on the communication bus 110 of the home appliance bus control system.

As shown in FIG. 4, the data collection device 310 transmits the collected communication data to the prejudge device 322. The prejudge device 322 judges in real-time whether the collected communication data meet a preset alarm condition. If the judgment result is yes, then the collection of the communication data is terminated; if the judgment result is no, then the collection of the communication data is continued. In an exemplary embodiment, as for each channel data that is monitored, the prejudge device 322 provides some alarm conditions. When the monitored actual data meet the alarm conditions, it may determine that there are problems in the operation of the home appliance. At this time, the collected communication data is abnormal and useless. Thereby, in this case, it needs to solve the problems and then continue to collect the communication data. For example, for the water temperature monitoring channel, if the water temperature is higher than 90 degrees, it determines that the home appliance is abnormal. In this case, the alarm condition may be set that the water temperature is higher than 90 degrees. When the alarm condition is met, it must stop the detection and check the channel and the circuit related to the water temperature, so as to solve the problems that cause the water temperature too high. After the problems are solved, it may continue to collect the communication data and continue to detect the home appliance bus control system.

After the collected communication data is preliminarily validated as normal data by the prejudge device 322, as shown in FIG. 4, the collected communication data is transmitted to the graphic device 324. The graphic device 324 generates and displays the actual test diagram of the communication data based on the collected communication data. In an embodiment, the graphic device 324 dynamically displays the channel data in real-time by a time sequence. The different channels may be distinguished by colors. In an exemplary embodiment of the actual test diagram, a Cartesian coordinate system is formed by the graphic device 324, wherein the time is set as the X axis, and the value of the collected channel data is set as the Y axis. After the collected data is displayed, the graphic device 324 may have a function to zoom in or zoom out on the actual test diagram in the X axis direction and/or the Y axis direction, and have a function to output the value of the collected channel data at a desired time point. Thereby, after detection, the value of the collected channel data at the desired time point may be simply displayed and viewed by zooming in or zooming out on the actual test diagram in the X axis direction and/or the Y axis direction, facilitating to observe the operation of home appliance.

The analysis device 326, shown in FIG. 4, analyzes the collected communication data based on the obtained actual test diagram of the communication data and obtain the analysis result. The analysis device 326 may realize the artificial data analysis or the automatic data analysis. As described above, in the Cartesian coordinate system of the graphic device 324, the time is set as the X axis, the value of the collected channel data is set as the Y axis. After the collected data is displayed, the graphic device 324 may have a function to zoom in or zoom out on the actual test diagram in the X axis direction and/or the Y axis direction, and have a function to output the value of the collected channel data at the desired time point. Thereby, the artificial data analysis may be realized by analyzing the data values in a period of time based on these functions of the graphic device 324, so as to determine whether the control logic of home appliance is normal. The automatic data analysis is made by comparing the actual value of the collected communication data with a predetermined desired value. If an error between the actual value and the predetermined desired value goes beyond a certain error value, a mark is signed on the actual test diagram of the communication data, the analysis personnel may find the errors in the control logic of the home appliance by analyzing the marks on the actual test diagram.

As shown in FIG. 4, the collected communication data and the obtained analysis result are stored in the storage device 328. The collected communication data may be stored as a format file, for example, a csv file or an xml file, so as to record the whole test process. The whole operation of the home appliance may be reproduced by reading out the stored format file. In this way, the test result not only includes of “passed” or “failed”, but also the data of the whole operation of the home appliance. The prejudge device 322, the graphic device 324, the analysis device 326, and the storage device 328 are realized by running the computer software on the processor of the detection apparatus 300.

The stored communication data, as shown in FIG. 4, may be read out from the storage device 328 and the actual test diagram of the collected communication data may be re-displayed. Thereby, the collected communication data may be re-analyzed manually or by the analysis device based on the re-displayed actual test diagram of the communication data.

A method of detecting a status of a home appliance bus control system according to the invention, as described above, therefore comprises the steps of:

S110: collecting communication data transmitted on the first communication bus 110;

S120: judging in real time and online whether the collected communication data meet the preset alarm condition; if the judgment result is yes, then terminating the collection of the communication data; if the judgment result is no, then continuing the collection of the communication data;

S130: graphically displaying the collected communication data to obtain the actual test diagram of the collected communication data; and

S140: analyzing the collected communication data based on the obtained actual test diagram of the collected communication data to obtain an analysis result.

The status of the home appliance bus control system is automatically detected by the detection apparatus 300 connected to the first communication bus 110 of the home appliance bus control system.

In an embodiment, the above method may further comprise steps of:

S150: storing the collected communication data and the obtained analysis result.

S160: reading out the stored communication data, and re-displaying the actual test diagram of the collected communication data; and

S170: re-analyzing the collected communication data manually or by the analysis device 326 based on the re-displayed actual test diagram of the communication data.

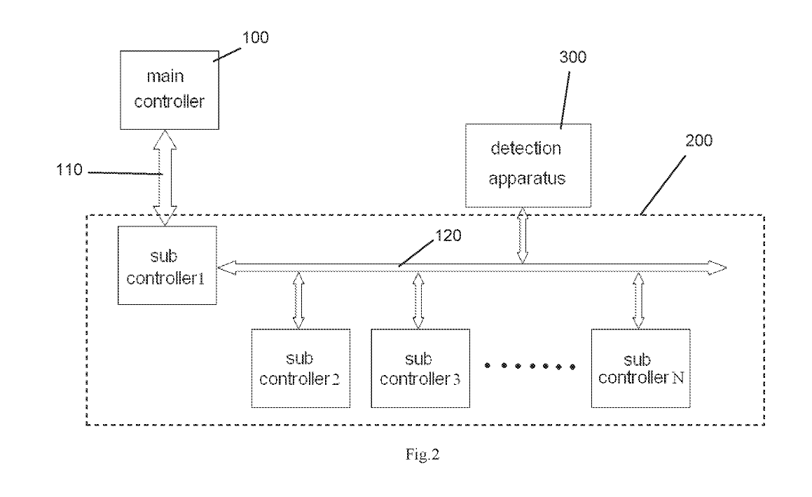

A home appliance bus control system according to another embodiment of the invention is shown in FIG. 2. Like reference numbers indicate like elements with respect to the embodiment shown in FIG. 1 and only the differences from the embodiment shown in FIG. 1 will be described in detail herein.

In the embodiment shown in FIG. 1, the detection apparatus 300 is connected to the first communication bus 110 between the main controller 100 and the sub controller 1. While, in the embodiment shown in FIG. 2, the detection apparatus 300 is connected to the second communication bus 120 to which the sub controller 1, the sub controller 2, the sub controller 3, . . . , the sub controller N are connected in parallel. Except for this, the home appliance bus control system shown in FIG. 2 is same as the home appliance bus control system shown in FIG. 1; the detection device 300 itself is configured and functions in the same manner as the detection device 300 shown in FIGS. 1 and 4.

A method of detecting a status of a home appliance bus control system shown in FIG. 2 therefore comprises the steps of:

S210: collecting communication data transmitted on the second communication bus 120;

S220: judging in real-time and online whether the collected communication data meet a preset alarm condition; if the judgment result is yes, then terminating the collection of the communication data; if the judgment result is no, then continuing the collection of the communication data;

S230: graphically displaying the collected communication data to obtain an actual test diagram of the collected communication data; and

S240: analyzing the collected communication data based on the obtained actual test diagram of the collected communication data to obtain an analysis result.

The above method may further comprise the steps of:

S250: storing the collected communication data and the obtained analysis result.

S260: reading out the stored communication data, and re-displaying the actual test diagram of the collected communication data; and

S270: re-analyzing the collected communication data manually or by the analysis device 326 based on the re-displayed actual test diagram of the communication data.

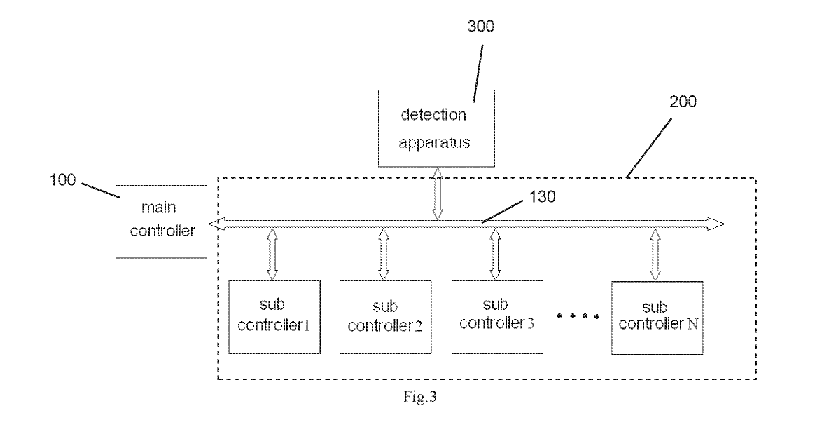

A home appliance bus control system according to another embodiment of the invention is shown in FIG. 3. Like reference numbers indicate like elements with respect to the embodiment shown in FIG. 1 and only the differences from the embodiment shown in FIG. 1 will be described in detail herein.

In the embodiment shown in FIG. 3, the home appliance bus control system only has a common communication bus 130 instead of the first communication bus 110 and the second communication bus 120 in the embodiment of FIG. 1. As shown in FIG. 3, the main controller 100 and the plurality of sub controllers are connected to the common communication bus 130 in parallel. The detection apparatus 300 is also connected to the common communication bus 130.

A method of detecting a status of a home appliance bus control system shown in FIG. 3 therefore comprises the steps of:

S310: collecting communication data transmitted on the common communication bus 130;

S320: judging in real-time and online whether the collected communication data meet a preset alarm condition; if the judgment result is yes, then terminating the collection of the communication data; if the judgment result is no, then continuing the collection of the communication data;

S330: graphically displaying the collected communication data, and obtaining an actual test diagram of the collected communication data; and

S340: analyzing the collected communication data based on the obtained actual test diagram of the collected communication data, and obtaining an analysis result.

The above method may further comprise the steps of:

S350: storing the collected communication data and the obtained analysis result.

S360: reading out the stored communication data, and re-displaying the actual test diagram of the collected communication data; and

S370: re-analyzing the collected communication data manually or by the analysis device 326 based on the re-displayed actual test diagram of the communication data.

What is claimed is:

1. A method of detecting a status of a home appliance control system, comprising:
collecting communication data transmitted on a communication bus of the home appliance bus control system;
judging in real-time and online whether the collected communication data meet a preset alarm condition, terminating the collection of the communication data if the collected communication data meet the preset alarm condition and continuing the collection of the communication data if the collected communication data do not meet the preset alarm condition;
graphically displaying the collected communication data to obtain an actual test diagram of the collected communication data; and
analyzing the collected communication data based on the actual test diagram of the collected communication data to obtain an analysis result.

2. The method of claim 1, wherein a detection apparatus connected to the communication bus automatically performs the collecting, judging, graphically displaying, and analyzing steps.

3. The method of claim 2, wherein the detection apparatus has a data collection device configured to perform the collecting step.

4. The method of claim 3, wherein the detection apparatus has a prejudge device performing the judging step.

5. The method of claim 4, wherein the detection apparatus has a graphic device performing the graphically displaying step.

6. The method of claim 5, wherein the detection apparatus has an analysis device performing the analyzing step.

7. The method of claim 2, further comprising a step of storing the collected communication data and the analysis result.

8. The method of claim 7, wherein the detection apparatus has a storage device performing the storing step.

9. The method of claim 8, further comprising a step of reading out the stored communication data and re-displaying the actual test diagram.

10. The method of claim 9, further comprising a step of re-analyzing the collected communication data based on the re-displayed actual test diagram.

11. The method of claim 2, wherein the home appliance bus control system comprises a main controller and a sub controller system having a plurality of sub controllers.

12. The method of claim 11, wherein the main controller is connected to one of the plurality of sub controllers through a first communication bus.

13. The method of claim 12, wherein the plurality of sub controllers are connected to a second communication bus in parallel.

14. The method of claim 13, wherein the detection apparatus is connected to the first communication bus or the second communication bus.

15. The method of claim 14, wherein the main controller operates a main control logic of the home appliance and sends a control instruction to the one of the plurality of sub controllers connected to the main controller through the first communication bus.

16. The method of claim 15, wherein the one of the plurality of sub controllers transfers the control instruction to each of the other sub controllers and sends data of the other sub controllers back to the main controller, the sub controllers each configured to directly control an execution component and/or a sensing component based on the received control instruction.

17. The method of claim 11, wherein the main controller and the plurality of sub controllers are connected to a common communication bus in parallel.

18. The method of claim 17, wherein the detection apparatus is connected to the common communication bus.

19. The method of claim 18, wherein the main controller operates a main control logic of the home appliance, sends a control instruction to each of the plurality of sub controllers, and receives data sent back from each of the plurality of sub controllers.

20. The method of claim 19, wherein the sub controllers are each configured to receive the control instruction sent from the main controller and directly control an execution component and/or a sensing component based on the received control instruction.
